(19) United States
(12) Patent Application Publication
(10) Pub. No.: US 2015/0062969 A1
(43) Pub. Date: Mar. 5, 2015

(54) BACKLIGHT MODULE

(71) Applicant: AU Optronics Corporation, Hsin-Chu (TW)

(72) Inventors: Po-Chun CHEN, HSIN-CHU (TW); Ta-Chung TSAI, HSIN-CHU (TW)

(73) Assignee: AU Optronics Corporation, Hsin-Chu (TW)

(21) Appl. No.: 14/297,922

(22) Filed: Jun. 6, 2014

(30) Foreign Application Priority Data
Sep. 4, 2013 (TW) 102131871

(51) Int. Cl. F21V 8/00

(52) U.S. Cl. CPC G02B 6/0081
USPC 362/633

(57) ABSTRACT

A backlight module includes a back bezel, at least one frame, at least one fastener, a cushion and a light guide plate. The back bezel includes a bottom plate and at least one lateral plate. The lateral plate is adjoined to the bottom plate. The frame presses against the lateral plate. The fastener fastens the frame and the back bezel. The cushion is disposed on the bottom plate, and includes a cavity. Part of the fastener is located in the cavity. The light guide plate is disposed on one side of the cushion opposite to the bottom plate.

### RELATED APPLICATIONS

This application claims priority to Taiwan Application Serial Number 102131871, filed Sep. 4, 2013, which is herein incorporated by reference.

### BACKGROUND

1. Technical Field

Embodiments of the present invention relate to a backlight module. More particularly, embodiments of the present invention relate to a backlight module of a display apparatus.

2. Description of Related Art

The LCD (liquid crystal display) is one of the most popular display apparatus, in which a LCD panel and a backlight module are included. In particular, the LCD panel is disposed on the backlight module which provides an illumination to the LCD panel, such that the viewer can see the image through the LCD panel.

A typical backlight module includes a light source, a light guide plate, a back bezel and a frame. The light guide plate has two opposite main surfaces and plural side surfaces connected to the main surfaces. The light source can be disposed on the main surface of the light guide plate that is opposite to the LCD panel, so as to form a direct type backlight module. Alternatively, the light source can be disposed on the side surface of the light guide plate as well, so as to form an edge lit type backlight module. In a typical backlight module, as shown in FIG. 1, the light guide plate 21 is supported by the cushion 26, and the cushion 26 is disposed on the back bezel 22. The back bezel 22 and the frames 23, 24 can be fastened by the screw 25. In order to fasten the back bezel 22 and the frames 23, 24 by the screw 25, the back bezel 22 is tapped and drilled to form the threaded hole.

However, during the tapping and drilling process, powdery debris is introduced. If the powdery debris is not removed, it may enter the backlight module with the screw 25 being screwed through the back bezel 22, which may damage the light guide plate 21 or the optical films on the light guide plate 21.

### SUMMARY

Embodiments of the invention provide a backlight module that can prevent the debris generated during the drilling and tapping process from damaging the light guide plate.

In accordance with one embodiments of the present invention, a backlight module includes a back bezel, at least one frame, at least one fastener, a cushion and a light guide plate. The back bezel includes a bottom plate and at least one lateral plate adjoined to the bottom plate. The frame abuts against the lateral plate. The fastener fastens the frame and the back bezel. The cushion is disposed on the bottom plate. The cushion has a cavity. A part of the fastener is located in the cavity. The light guide plate is disposed on one side of the cushion opposite to the bottom plate.

In the foregoing embodiment, because the fastener screwed through the back bezel is located in the cavity, even though the debris is generated during the drilling and tapping process, and the debris can still get into the inside of the back bezel when screwing the screw. Therefore, the debris can be confined in the cavity, and do not damage the light guide plate on the cushion. Therefore, the backlight module in the foregoing embodiment can prevent the debris generated during the drilling and tapping process from damaging the light guide plate.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective cross-sectional view of a typical display apparatus;

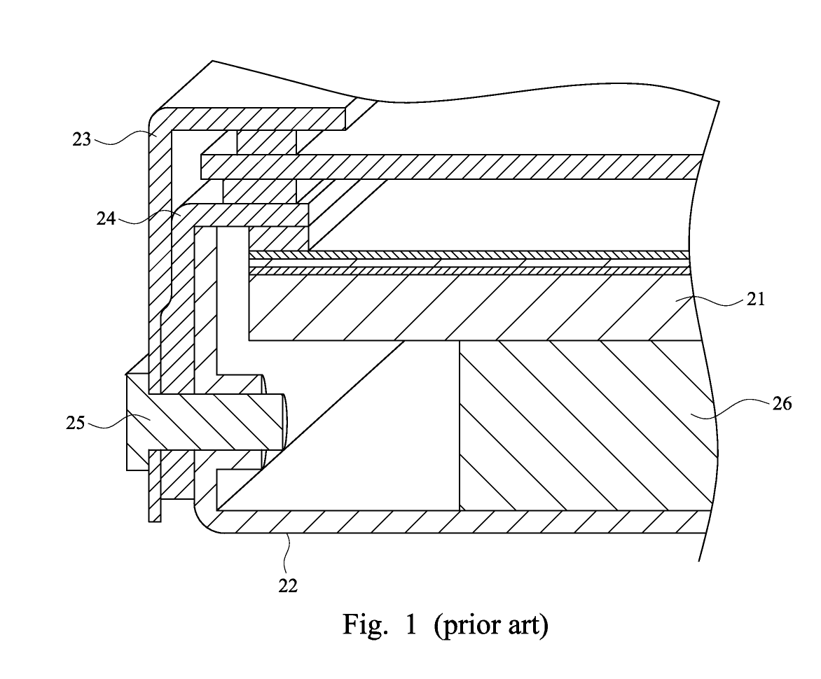

FIG. 2 is a top view of a display apparatus in accordance with one embodiment of the present invention;

FIG. 3 is a perspective cross-sectional view taken along A-A′ ling in FIG. 2;

FIG. 4 is a perspective view of the cushion in FIG. 3;

FIG. 5 is a perspective cross-sectional view of the display apparatus in accordance with another embodiment of the present invention;

FIG. 6 is a perspective cross-sectional view of the display apparatus in accordance with another embodiment of the present invention;

FIG. 7 is a perspective view of the cushion in accordance with another embodiment of the present invention;

FIG. 8 is a perspective cross-sectional view of the display apparatus in accordance with another embodiment of the present invention;

FIG. 9 is a perspective cross-sectional view of the display apparatus in accordance with another embodiment of the present invention;

FIG. 10 is an explosive view of the cushion shown in FIG. 9;

FIG. 11 is a perspective cross-sectional view of the display apparatus in accordance with another embodiment of the present invention;

FIG. 12 is an explosive view of the cushion in accordance with another embodiment of the present invention;

FIG. 13 is a perspective cross-sectional view of the display apparatus in accordance with another embodiment of the present invention; and

FIG. 14 is a perspective cross-sectional view of the display apparatus in accordance with another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

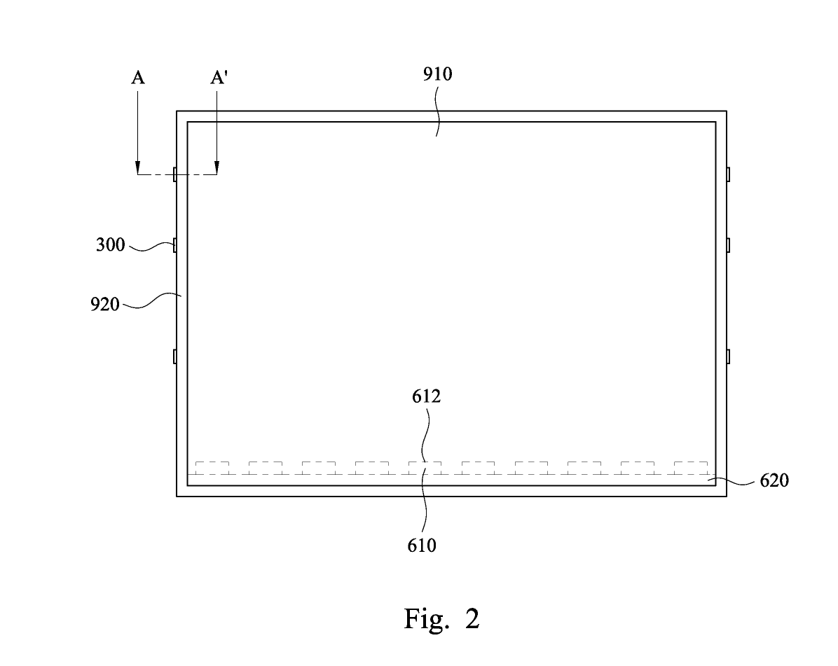

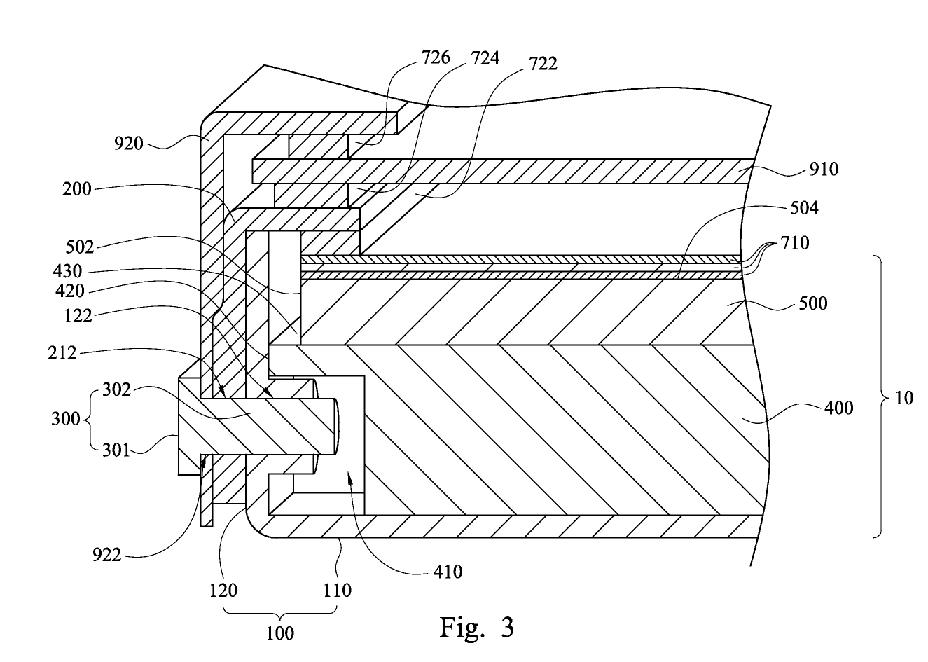

FIG. 2 is a top view of a display apparatus in accordance with one embodiment of the present invention. FIG. 3 is a perspective cross-sectional view taken along A-A′ line in FIG. 2. As shown in FIGS. 2 and 3, in this embodiment, the backlight module 10 is located under the display panel 910. The backlight module 10 may include a back bezel 100, at least one frame 200, at least one fastener 300, a cushion 400 and a light guide plate 500. The back bezel 100 may include a bottom plate 110 and at least one lateral plate 120. As shown in FIG. 3, the lateral plate 120 is adjoined to the bottom plate 110. In some embodiments, the lateral plate 120 may be substantially perpendicular to the bottom plate 110. The frame 200 abuts against the lateral plate 120. A front bezel 920 is disposed outside the display panel 910. The fastener 300 fastens the front bezel 920 and the frame 200 to the lateral plate 120 of the back bezel 100. The cushion 400 is disposed on the bottom plate 110. The cushion 400 is located inside the lateral plate 120, and the frame 200 is located outside the lateral plate 120 opposite to the cushion 400. The cushion 400 includes a cavity 410. A part of the fastener 300 is located in the cavity 410. The light guide plate 500 is disposed on one side of the cushion 400 opposite to the bottom plate 110, such that the cushion 400 can support the light guide plate 500.

In this embodiment, the lateral plate 120 of the back bezel 100 abuts against the frame 200. The lateral plate 120 has a threaded hole 122, and the frame 200 has a hole 212, and the front bezel 920 has a hole 922 as well. The fastener 300 is located through the holes 922, 212 and the threaded hole 122, so as to fasten the front bezel 920 and the frame 200 to the back bezel 100. In this embodiment, the threaded hole 122 of the lateral plate 120 can be formed by drilling and tapping process, and therefore, debris may remain in the threaded hole 122. When the fastener 300 is screwed through the threaded hole 122, it may move the debris away from the threaded hole 122, and the debris may fall inside the lateral plate 120 opposite to the frame 200. However, when the fastener 300 is screwed though the threaded hole 122, it is accommodated in the cavity 410, and therefore, even though the fastener 300 may move the debris inside the back bezel 100 opposite to the frame 200, these debris can be confined in the cavity 410, and do not damage the light guide plate 500 on the cushion 400. Therefore, the backlight module in the foregoing embodiment can effectively prevent the debris from damaging the light guide plate 500, such as scratching the light guide plate 500.

As shown in FIG. 3, the fastener 300 may be a screw. For example, the fastener 300 may includes a screw head 301 and a bolt 302. The screw head 301 is connected to the bolt 302. When the fastener 300 fastens the front bezel 920 and the frame 200 to the lateral plate 120, the screw head 301 abuts against the outside of the front bezel 920 opposite to the frame 200, and the bolt 320 is located through the holes 922, 212 and the threaded hole 122. The tip of the bolt 302 farthest from the screw head 301 is exposed in the cavity 410.

As shown in FIG. 3, the cushion 400 includes a surface 420 faced to the lateral plate 120. In some embodiments, the surface 420 of the cushion 400 abuts against the lateral plate 120, so that there is no gap between the surface 420 of the cushion 400 and the lateral plate 120, which further prevents the debris in the cavity 410 from moving above the cushion 400 and damaging the light guide plate 500. It is understood that “an element abuts against another element” means that these two elements are in contact with each other. For example, “the surface 420 of the cushion 400 abuts against the lateral plate 120 means that the surface 420 of the cushion 400 is in contact with the lateral plate 120, and therefore, there is no gap between the surface 420 of the cushion 400 and the lateral plate 120. In this embodiment, the cushion 400 is integrally formed as one piece, and the material thereof can be, but is not limited to be, the foaming material for providing the buffering ability.

In some embodiments, as shown in FIG. 3, the light guide plate 500 has at least one light incident surface 502 and a light emitting surface 504 adjoined to the light incident surface 502. The backlight module 10 includes at least one optical film 710. The optical film 710 is disposed on the light emitting surface 504 of the light guide plate 500. The backlight module 10 includes a plurality of light sources 610 (See FIG. 2). Each of the light sources 610 has a lighting surface 612. The lighting surfaces 612 are substantially parallel to the light incident surface 502 of the light guide plate 500 (See FIG. 3), so that the light sources 610 can emit lights toward the light incident surface 502, and the lights emitted into the light guide plate 500 can go into the optical films 710 (See FIG. 3) through the light emitting surface 504. Then, the lights can enter into the display panel 910 through the optical films 710. As such, the backlight module 10 can be, but is not limited to be, a direct type backlight module. In some embodiments, the light sources 610 can be, but are not limited to be, LEDs (light emitting diodes). In some embodiments, one of the optical films 710 can be a diffuser, BEF (brightness enhancement film) or other film, and it can be chosen based on demands.

In some embodiments, as shown in FIG. 3, a orthogonal projection of the frame 200 and a orthogonal projection of the optical films 710 onto the light guide plate 500 are overlapped. As such, the frame 200 can press the optical films 710 onto the light guide plate 500. Moreover, in some embodiments, the backlight module 10 may include a protector 722. The protector 722 is sandwiched between the frame 200 and the optical films 710, so as to protect the optical films 710. Further, a protector 724 can be alternatively sandwiched between the display panel 910 and the frame 200, and a protector 726 can be alternatively sandwiched between the display panel 910 and the front bezel 920. In other words, the display panel 910 is sandwiched between the protectors 724 and 726, such that it can be fixed and protected by the protectors 724 and 726. The protectors 724 and 726 can be, but are not limited to be, formed by rubber, sponge or foaming material.

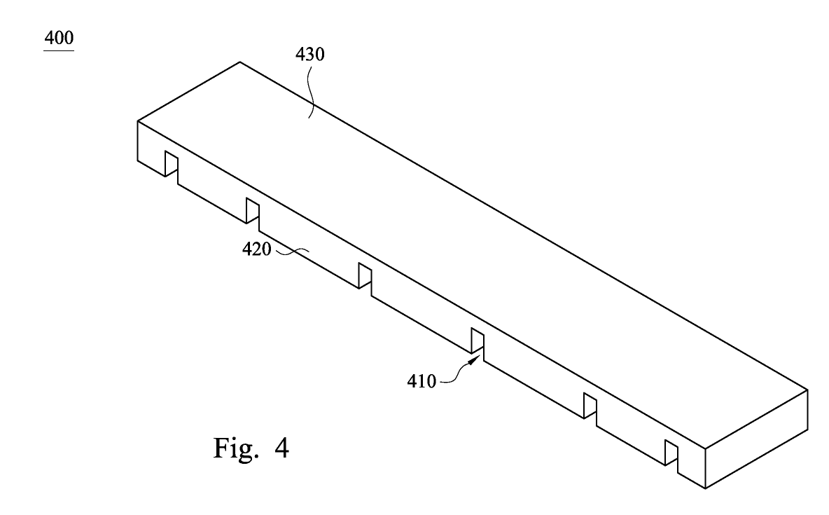

FIG. 4 is a perspective view of the cushion 400 in FIG. 3. As shown in FIG. 4, the cushion 400 has a surface 430. The surface 430 is adjoined to the surface 420, and in some embodiments, the surfaces 430 and 420 are substantially perpendicular to each other. As shown in FIG. 3, the surface 430 is faced to the light guide plate 500. In some embodiments, the light guide plate 500 can be in contact with the surface 430 of the cushion 400.

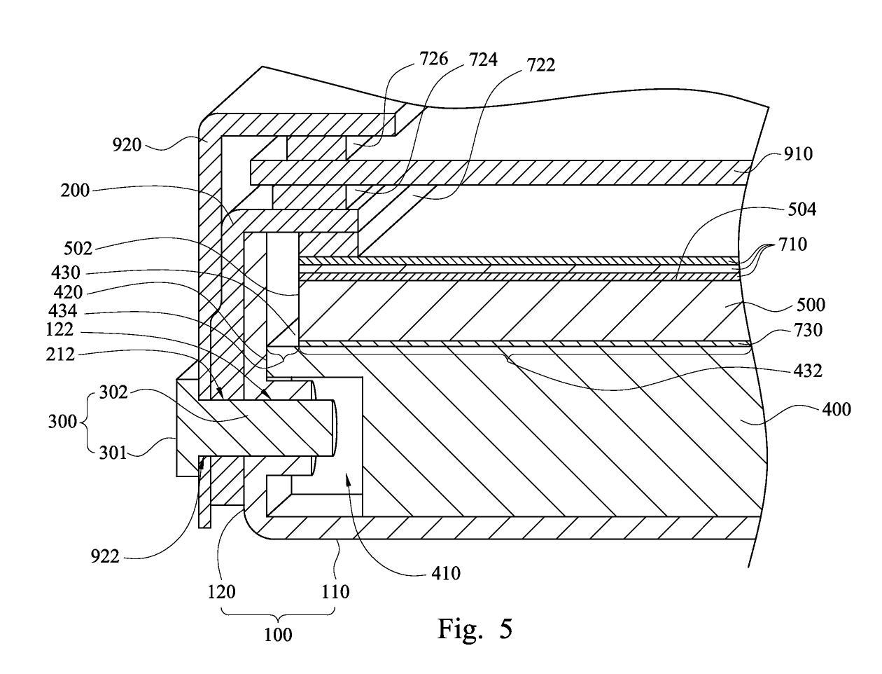

FIG. 5 is a perspective cross-sectional view of the display apparatus in accordance with another embodiment of the present invention. The main difference between this embodiment and which is shown in FIG. 3 is that a reflective layer 730 is disposed on the surface 430 of the cushion 400. The reflective layer 730 can reflect the lights emitted by the light sources 610 (See FIG. 2) toward the optical films 710. The surface 430 of the cushion 400 has a first area 432 and a second area 434. The second area 434 is adjoined to the first area 432. In this embodiment, the reflective layer 730 is only disposed on the first area 432 of the surface 430 of the cushion 400. The light guide plate 500 is located on the reflective layer 730.

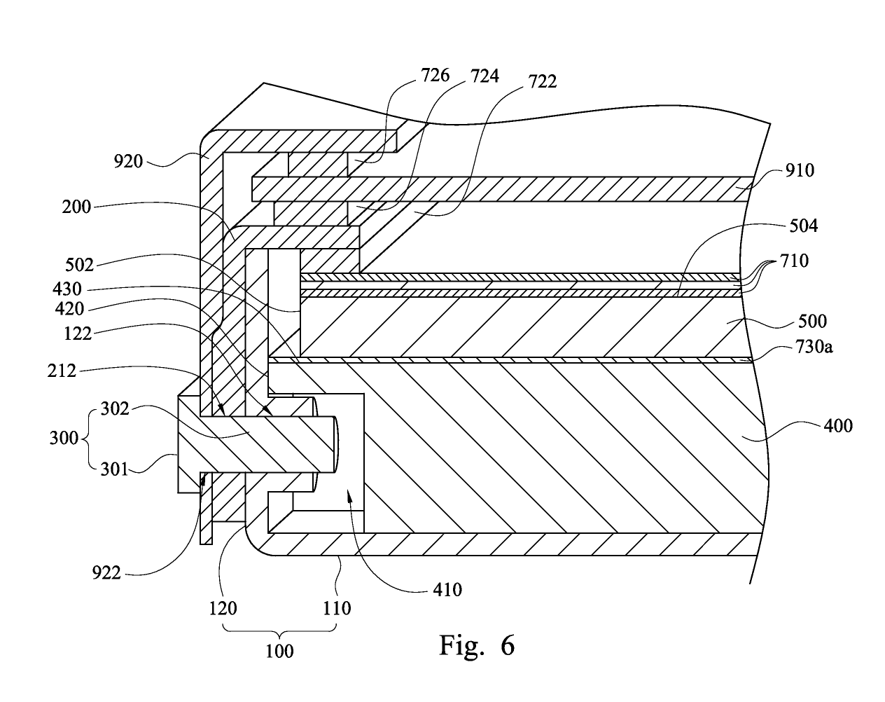

FIG. 6 is a perspective cross-sectional view of the display apparatus in accordance with another embodiment of the present invention. The main difference between this embodiment and which is shown in FIG. 5 is that the reflective layer 730a covers the whole surface 430 of the cushion 400.

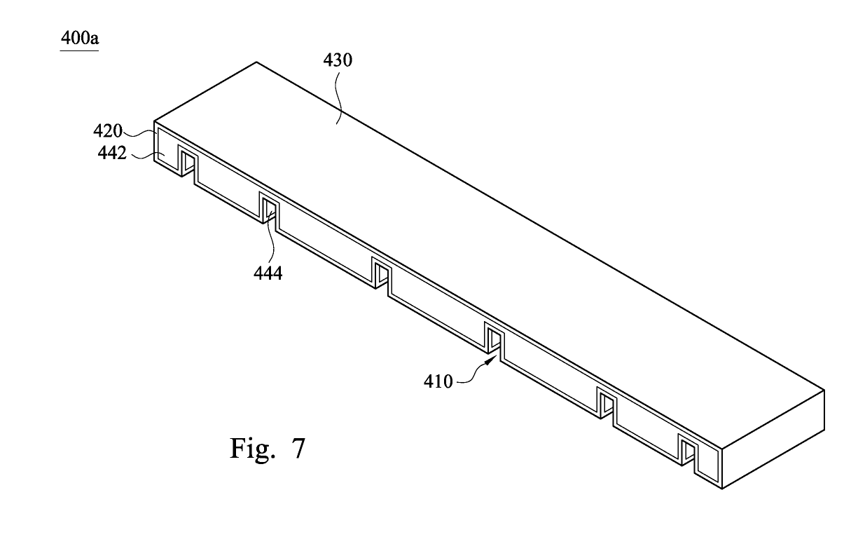

FIG. 7 is a perspective view of the cushion 400a in accordance with another embodiment of the present invention. The main difference between the cushion 400a and the cushion 400 is that the cushion 400a includes an adhesive layer 442. The adhesive layer 442 is disposed on the surface 420 of the cushion 400a, and this surface 420 is faced to and abuts against the lateral plate 120 (See FIG. 6). As such, if a gap is formed between the surface 420 of the cushion 400a and the lateral plate 120, even though debris may move from the cavity 410 to the gap, it can be adhered to the adhesive layer 442. Therefore, the adhesive layer 442 can protect the light guide plate 500 (See FIG. 6) on the surface 430 of the cushion 400a from the debris. Further, the adhesive layer 442 can adhere the cushion 400a to the lateral plate 120 as well, so as to fix the cushion 400a. It is noted that, in this embodiment, the adhesive layer 442 is depicted as only covering a partial surface 420 of the cushion 400a in order to facilitate the reader can clearly see the adhesive layer 442 in FIG. 7. In other embodiments, the adhesive layer 442 can also cover the whole surface 420 of the cushion 400a.

In some embodiments, as shown in FIG. 7, the cushion 400a may include another adhesive layer 444. The adhesive layer 444 is disposed on the wall defining the cavity 410. In this configuration, when the debris falls into the cavity 410, it can be adhered to the adhesive layer 444 that is disposed on the wall defining the cavity 410. Hence, the adhesive layer 444 can prevent the debris from moving and can thereby protect the light guide plate 500 (See FIG. 6) on the surface 430 of the cushion 400a from the debris. It is noted that, in this embodiment, the adhesive layer 444 is depicted as only covering a partial wall defining the cavity 410 in order to facilitate the reader can clearly see the adhesive layer 444 in FIG. 7. In other embodiments, the adhesive layer 444 can also cover the whole wall defining the cavity 410.

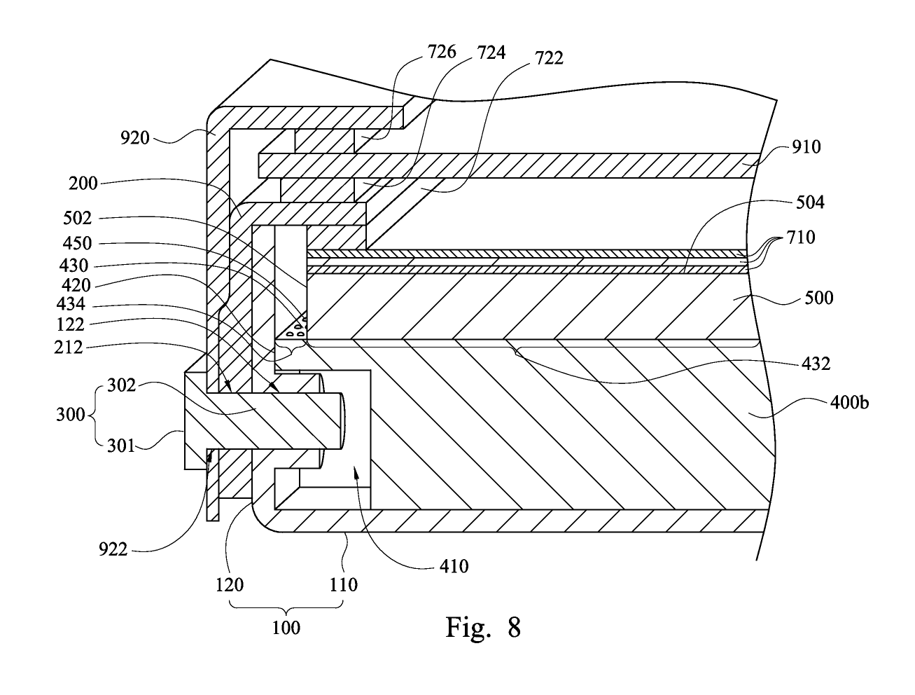

FIG. 8 is a perspective cross-sectional view of the display apparatus in accordance with another embodiment of the present invention. The main difference between this embodiment and which is shown in FIG. 3 is that the cushion 400b has a blocking structure 450 on the surface 430 of the cushion 400b faced to the light guide plate 500, so as to position the light guide plate 500, thereby preventing the light guide plate 500 from moving on the cushion 400b. In particular, the light guide plate 500 is located on the first area 432 of the surface 430. The blocking structure 450 is disposed on the second area 434 of the surface 430. In other words, the blocking structure 450 is located on the area of the cushion 400b not covered by the light guide plate 500. As such, when the light guide plate 500 is located on the first area 432, the light guide plate 500 abuts against the blocking structure 450, thereby positioning the light guide plate 500. Therefore, even if the light guide plate 500 may shake during the transferring process of the display apparatus, the blocking structure 450 may block the light guide plate 500, so as to protect the lateral plate 120.

In some embodiments, as shown in FIG. 8, the blocking structure 450 may be an uneven microstructure, and the protruded portion of the uneven microstructure can block the light guide plate 500. The uneven microstructure may be, but is not limited to be, formed on the surface 430 of the cushion 400b by rolling process. In some embodiments, the blocking structure 450 may be a rib that is at least protruded on the boundary between the first area 432 and the second area 434, so as to block the light guide plate 500.

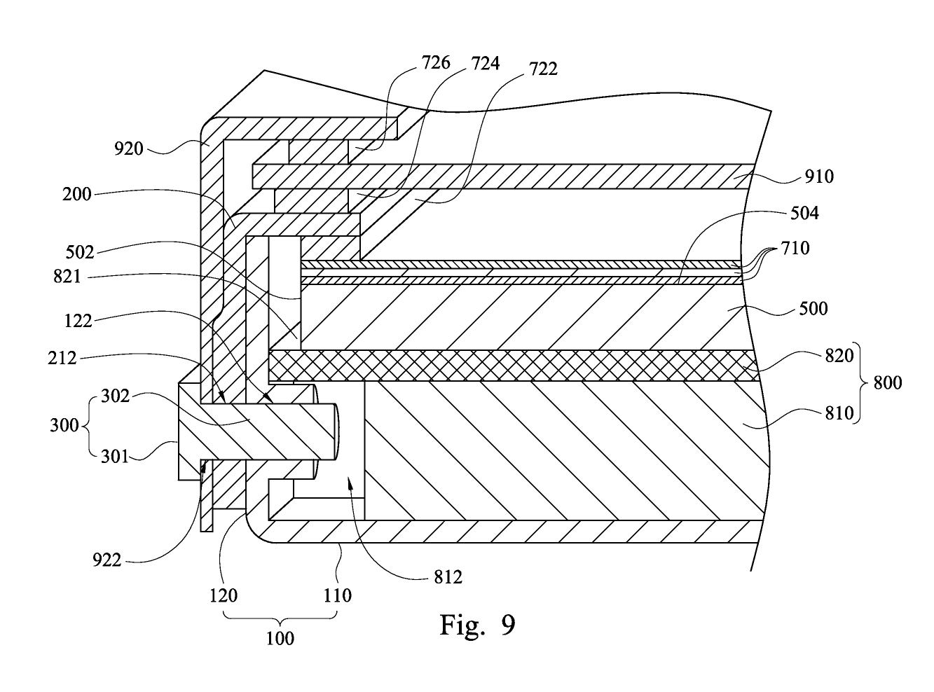

FIG. 9 is a perspective cross-sectional view of the display apparatus in accordance with another embodiment of the present invention. As shown in FIG. 9, the main difference between this embodiment and which is shown in FIG. 3 is that the cushion 800 includes a bottom buffering structure 810 and a top buffering structure 820 attached to each other. In other words, the cushion 800 is not integrally formed as one piece. The top buffering structure 820 is disposed on the bottom buffering structure 810. The cavity 812 is located on the bottom buffering structure 810. The top buffering structure 820 covers the cavity 812 and abuts against the lateral plate 120.

Because the top buffering structure 820 abuts against the lateral plate 120, no gap is formed between the top buffering structure 820 and the lateral plate 120, which prevents the debris from moving above the top damping structure 820 and from damaging the light guide plate 500.

In some embodiments, not only the top buffering structure 820 abuts against the lateral plate 120, but the bottom buffering structure 810 also abuts against the lateral plate 120, so as to prevent the debris in the cavity 812 from escaping out of the cavity 812.

In some embodiments, as shown in FIG. 9, the top buffering structure 820 has a surface 821. The surface 821 of the top buffering structure 820 is faced to the light guide plate 500. In particular, in some embodiments, the light guide plate 500 can be in contact with the surface 821 of the top buffering structure 820.

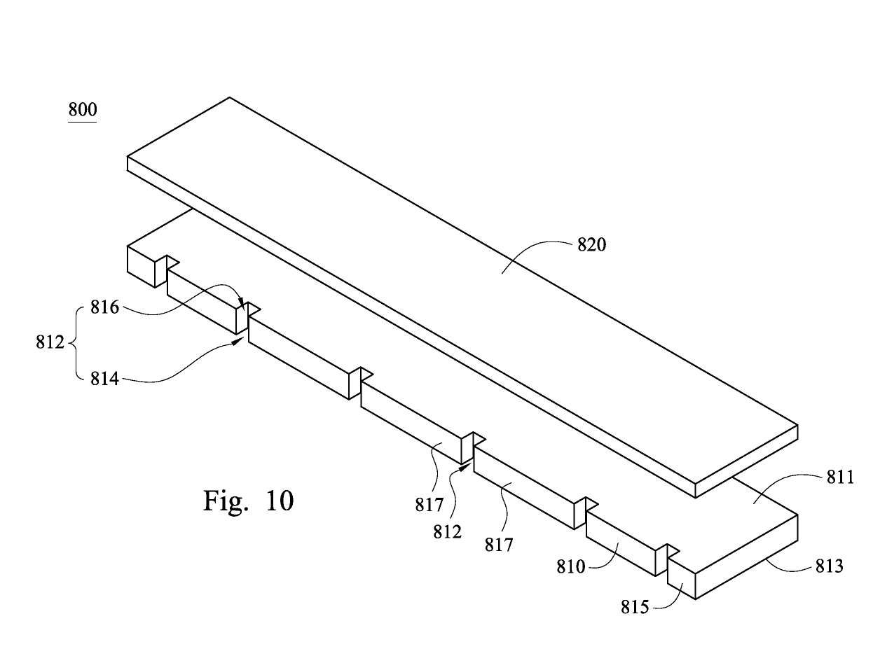

FIG. 10 is an explosive view of the cushion 800 shown in FIG. 9. As shown in FIG. 10, the cavity 812 has a first opening 814 and a second opening 816. The first opening 814 is faced to the fastener 300 (See FIG. 9). The top buffering structure 820 covers the second opening 816. In this configuration, when the fastener 300 is screwed through the threaded hole 122 (See FIG. 9), such that the debris in the threaded hole 122 falls into the cavity 812 through the first opening 814, the top buffering structure 820 can prevent the debris in the cavity 812 from escaping out of the cavity 812 through the second opening 816.

In some embodiments, as shown in FIG. 10, the bottom buffering structure 810 has surfaces 811, 813 and 815. The surfaces 811 and 813 are opposite to each other, and the surface 815 connects the surfaces 811 and 813. The top buffering structure 820 is located on the surface 811 of the bottom buffering structure 810. The cavity 812 extends through the surfaces 811 and 813 of the bottom buffering structure 810. Because the cavity 812 extends through the surfaces 811 and 813, the cavity 812 can be formed by punching process, rather than by drilling the surface 815 inwardly. For example, the cavity 812 can be formed by punching the surface 811 downwardly, or by punching the surface 813 upwardly, so that the cavity 812 can extend through the surfaces 811 and 813, and the punching process is simpler than drilling the surface 815 inwardly. In some embodiments, the material of the bottom buffering structure 810 and which of the top buffering structure 820 can be, but are not limited to be, the foaming material for providing the buffering ability.

In some embodiments, the bottom buffering structure 810 includes at least two protrusions 817. The cavity 812 is located between the protrusions 817. The protrusions 817 abut against the lateral plate 120 (See FIG. 9).

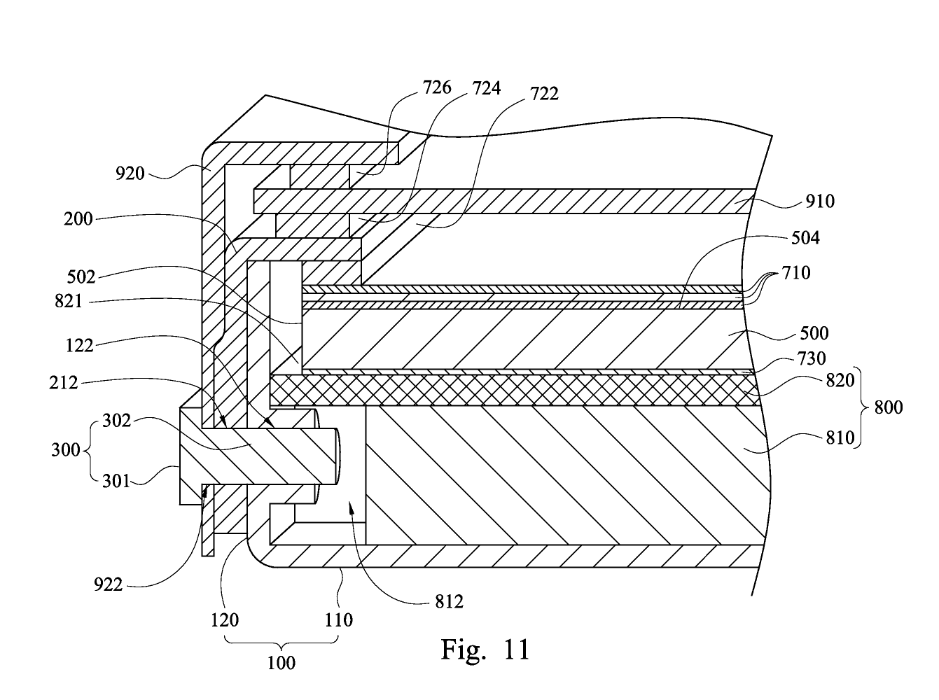

FIG. 11 is a perspective cross-sectional view of the display apparatus in accordance with another embodiment of the present invention. As shown in FIG. 11, the main difference between this embodiment and which is shown in FIG. 10 is that a reflective layer 730 is disposed on the surface 821 of the top buffering structure 820. The reflective layer 730 can reflect the lights emitted by the light sources 610 (See FIG. 2) toward the optical films 710. In this embodiment, the reflective layer 730 is only located on a partial area of the surface 821 of the top buffering structure 820, such as the area that is covered by the light guide plate 500. In other embodiments, the reflective layer 730 can cover the whole surface 821 of the top buffering structure 820.

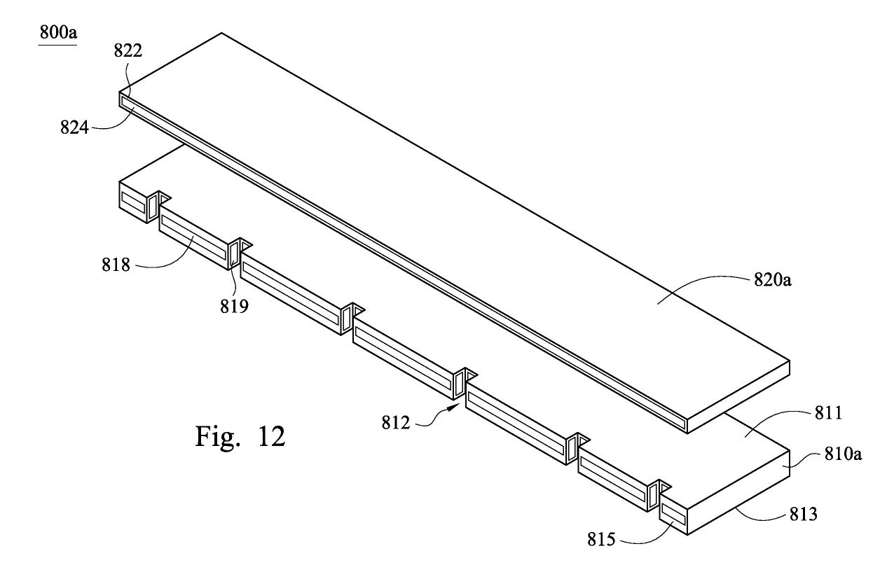

FIG. 12 is an explosive view of the cushion 800a in accordance with another embodiment of the present invention. As show in FIG. 12, the main difference between the cushion 800a and the foregoing cushion 800 is that the bottom buffering structure 810a includes an adhesive layer 818. The adhesive layer 818 is disposed on the surface 815 of the bottom buffering structure 810a, and this surface 815 is faced to the lateral plate 120 (See FIG. 11). As such, if a gap is formed between the surface 815 of the bottom buffering structure 810a and the lateral plate 120, even though some debris may move from the cavity 812 to the gap, it can be adhered to the adhesive layer 818. Therefore, the adhesive layer 818 can protect the light guide plate 500 (See FIG. 11). Further, the adhesive layer 818 can adhere the bottom buffering structure 810a to the lateral plate 120 as well, so as to fix the bottom buffering structure 810a. It is noted that, in this embodiment, the adhesive layer 818 is depicted as only covering a partial surface 815 of the bottom buffering structure 810a in order to facilitate the reader can clearly see the adhesive layer 818 in FIG. 12. In other embodiments, the adhesive layer 818 can also cover the whole surface 815 of the bottom buffering structure 810a.

In some embodiments, as shown in FIG. 12, the bottom buffering structure 810a may include another adhesive layer 819. The adhesive layer 819 is disposed on the wall defining the cavity 812. In this configuration, when the debris falls into the cavity 812, it can be adhered to the adhesive layer 819 disposed on the wall defining the cavity 812. Hence, the adhesive layer 819 can prevent the debris from moving and can thereby protect the light guide plate 500 (See FIG. 11). It is noted that, in this embodiment, the adhesive layer 819 is depicted as only covering a partial wall defining the cavity 812 in order to facilitate the reader can clearly see the adhesive layer 819. In other embodiments, the adhesive layer 819 can also cover the whole wall defining the cavity 812.

In some embodiments, as shown in FIG. 12, the top buffering structure 820a includes a surface 822 and an adhesive layer 824. The surface 822 of the top buffering structure 820a is faced to the lateral plate 120 (See FIG. 11). The adhesive layer 824 is disposed on the surface 822 of the top buffering structure 820a. As such, if a gap is formed between the surface 822 of the top buffering structure 820a and the lateral plate 120, even though the debris may move from the cavity 812 to the gap, it can be adhered to the adhesive layer 824. Therefore, the adhesive layer 824 can protect the light guide plate 500 (See FIG. 11). Further, the adhesive layer 824 can adhere the top buffering structure 820a to the lateral plate 120 as well, so as to fix the top buffering structure 820a. It is noted that, in this embodiment, the adhesive layer 824 is depicted as only covering a partial surface 822 of the top buffering structure 820a in order to facilitate the reader can clearly see the adhesive layer 824. In other embodiments, the adhesive layer 824 can also cover the whole surface 822 of the top buffering structure 820a.

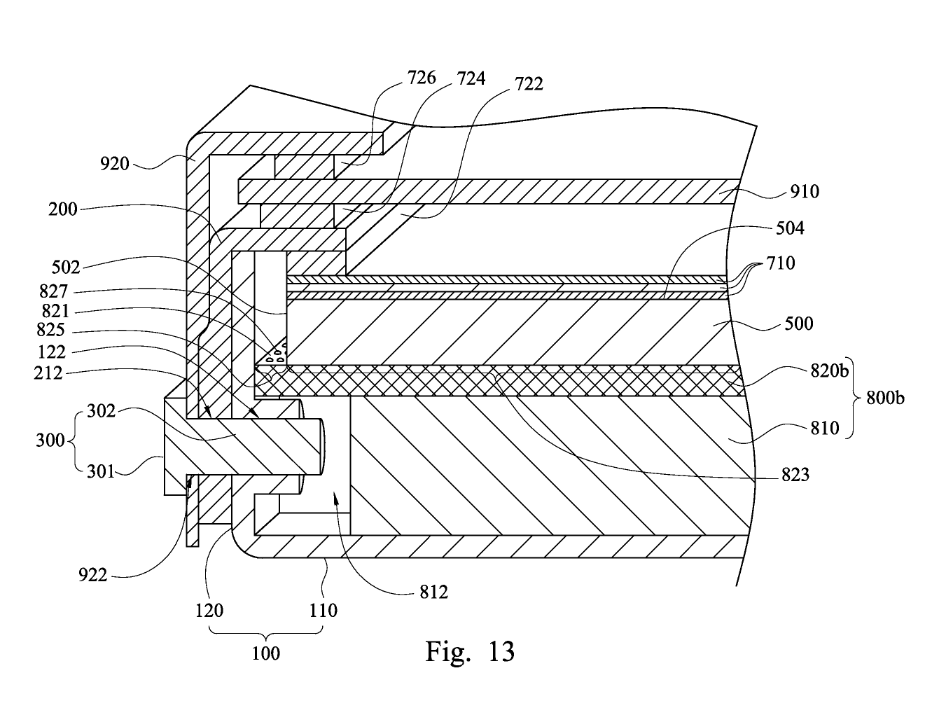

FIG. 13 is a perspective cross-sectional view of the display apparatus in accordance with another embodiment of the present invention. As shown in FIG. 13, the main difference between this embodiment and which is shown in FIG. 9 is the cushion 800b. In particular, the top buffering structure 820b has a blocking structure 827 thereon for positioning the light guide plate 500, thereby preventing the light guide plate 500 from moving on the top buffering structure 820b. In particular, the surface 821 of the top buffering structure 820b has a first area 823 and a second area 825. The first area 823 is adjoined to the second area 825. The light guide plate 500 is located on the first area 823. The blocking structure 827 is disposed on the second area 825. In other words, the blocking structure 827 is located on the area of the top buffering structure 820b that is not covered by the light guide plate 500. As such, when the light guide plate 500 is located on the first area 823, the light guide plate 500 can abut against the blocking structure 827 for positioning itself. Therefore, even if the light guide plate 500 may shake during the transferring process of the display apparatus, the blocking structure 827 may block the light guide plate 500, so as to protect the lateral plate 120.

In some embodiments, as shown in FIG. 13, the blocking structure 827 may be an uneven microstructure, and the protruded portion of the uneven microstructure can block the light guide plate 500. The uneven microstructure may be, but is not limited to be, formed on the surface 821 of the top buffering structure 820b by rolling process. In some embodiments, the blocking structure 827 may be a rib that is at least protruded on the boundary between the first area 823 and the second area 825 of the surface 821, so as to block the light guide plate 500.

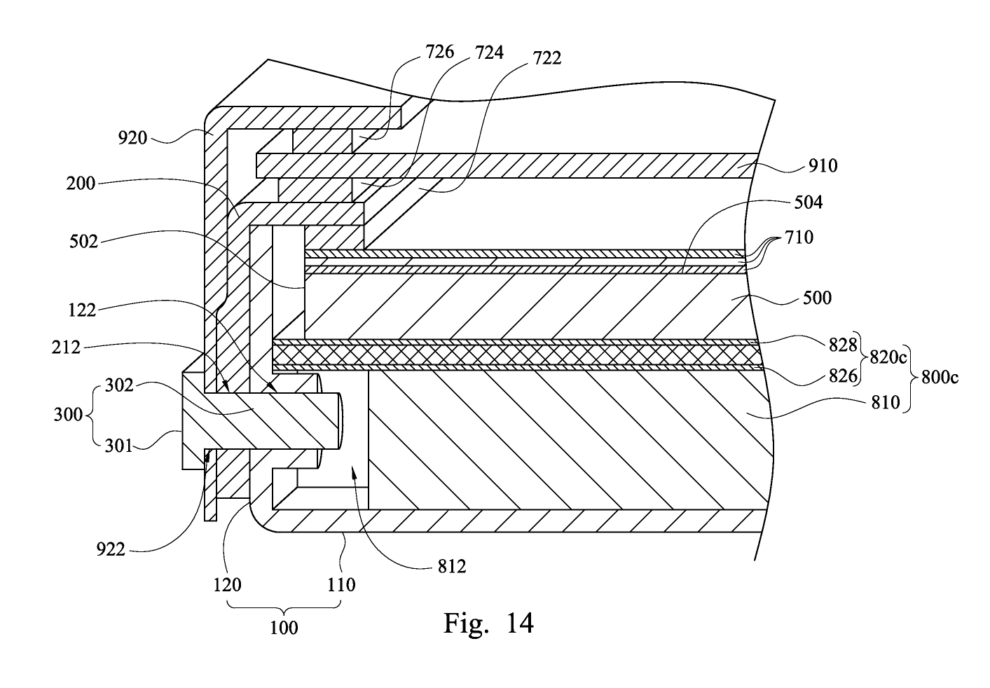

FIG. 14 is a perspective cross-sectional view of the display apparatus in accordance with another embodiment of the present invention. As shown in FIG. 14, the main difference between this embodiment and which is shown in FIG. 9 is the cushion 800c. In particular, the top buffering structure 820c includes two adhesive layers 826 and 828. The glue layer 826 is faced to the bottom buffering structure 810. The glue layer 828 is faced to the light guide plate 500. In other words, the top buffering structure 820c can be a double coated tape, in which the adhesive layers 826 and 828 can respectively adhere to the bottom buffering structure 810 and the light guide plate 500. By the adhesive layers 826 and 828, the top buffering structure 820c can fix the light guide plate 500, and can adhere to the debris escaping out of the cavity 812, so as to protect the light guide plate 500 from the debris.

In some embodiments, as shown in FIG. 2, the light sources 610 can be disposed on a heat dissipation structure 620, and the heat dissipation structure 620 is disposed on the bottom plate 110 (See FIG. 3). As such, when the light sources 610 emit lights, the generated heat can be transferred to the bottom plate 110 via the heat dissipation structure 620, so as to prevent the light sources 610 from overheated. In some embodiment, the heat dissipation structure 620 can be, but is not limited to be, a metal for transferring heat.

In some embodiments, a plurality of the lateral plates 120 (See FIG. 3) can be respectively connected to different edges of the bottom plate 110 (See FIG. 3). In order to improve the heat dissipation ability of the heat dissipation structure 620, the heat dissipation structure 620 (See FIG. 2) preferably abuts against one of the lateral plates 120 (See FIG. 3), and preferably, the lateral plate 120 abutted by the heat dissipation structure 620 is the one that doesn't has the fastener 300 therethrough, so as to protect the heat dissipation structure 620. Therefore, the cushion 400 (See FIG. 3) and the heat dissipation structure 620 preferably abut against different lateral plates 120.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A backlight module, comprising:
a back bezel comprising a bottom plate and at least one lateral plate adjoined to the bottom plate;
a frame abutting against the lateral plate;
a fastener fastening the frame and the back bezel;
a cushion disposed on the bottom plate, and the cushion having a cavity, wherein a part of the fastener is located in the cavity; and
a light guide plate disposed on one side of the cushion opposite to the bottom plate.

2. The backlight module of claim 1, further comprising an adhesive layer disposed on a surface of the cushion faced to the lateral plate.

3. The backlight module of claim 1, further comprising a reflective layer disposed on a surface of the cushion faced to the light guide plate.

4. The backlight module of claim 1, further comprising an adhesive layer disposed on a wall that defines the cavity.

5. The backlight module of claim 1, wherein a surface of the cushion faced to the light guide plate has a first area and a second area adjoined to the first area, and the light guide plate is located on the first area, and the second area has a blocking structure thereon for positioning the light guide plate.

6. The backlight module of claim 5, further comprising a reflective layer disposed on the first area.

7. The backlight module of claim 1, wherein the cushion has a bottom buffering structure and a top buffering structure disposed on the bottom buffering structure, and the cavity is located on the bottom buffering structure, and the top buffering structure covers the cavity and abuts against the lateral plate.

8. The backlight module of claim 7, wherein the cavity has a first opening and a second opening, and the first opening is faced to the fastener, and the top buffering structure covers the second opening.

9. The backlight module of claim 7, wherein the bottom buffering structure has two opposite surfaces, and the top buffering structure is disposed on one of the surfaces of the damping buffering structure, and the cavity penetrates through the surfaces of the bottom buffering structure.

10. The backlight module of claim 7, wherein the bottom buffering structure comprises at least two protrusions, and the cavity is located between the protrusions, and the protrusions abut against the lateral plate.

11. The backlight module of claim 7, further comprising an adhesive layer disposed on a surface of the bottom damping structure faced to the lateral plate.

12. The backlight module of claim 7, wherein the top buffering structure comprises two adhesive layers, wherein one of the adhesive layers is faced to the bottom damping structure, and another one of the adhesive layers is faced to the light guide plate.

13. The backlight module of claim 7, wherein the top buffering structure comprises an adhesive layer disposed on a surface of the top buffering structure faced to the lateral plate.

14. The backlight module of claim 7, further comprising a reflective layer disposed on a surface of the top buffering structure faced to the light guide plate.

15. The backlight module of claim 7, wherein the a surface of the top buffering structure faced to the light guide plate has a first area and a second area adjoined to the first area, and the light guide plate is located on the first area, and the second area has a blocking structure thereon for positioning the light guide plate.

16. The backlight module of claim 1, wherein the cushion is located inside the lateral plate, and the frame is located outside the lateral plate opposite to the cushion.
